(19) United States
(12) Patent Application Publication
(10) Pub. No.: US 2014/0028170 A1
(43) Pub. Date: Jan. 30, 2014

(54) Image Processing Apparatus

(71) Applicants: Sakae Ito, Kitanagoya-shi (JP); Kazuyoshi Minaminaka, Suzuka-shi (JP)

(72) Inventors: Sakae Ito, Kitanagoya-shi (JP); Kazuyoshi Minaminaka, Suzuka-shi (JP)

(73) Assignee: BROTHER KOGYO KABUSHIKI KAISHA, Nagoya-shi (JP)

(21) Appl. No.: 13/949,448

(22) Filed: Jul. 24, 2013

(30) Foreign Application Priority Data
Jul. 24, 2012 (JP) 2012-163687

(51) Int. Cl. G03G 21/16

(52) U.S. Cl. CPC G03G 21/16
USPC 312/327

(57) ABSTRACT

An image processing apparatus, comprising: a main body; a first movable part; a second movable part; a locking mechanism; and a detection unit to detect a state of the locking mechanism, and wherein the locking mechanism comprises: a stopper provided on one of the main body and the first movable part; and a catching part provided on the other of the main body and the first movable part, wherein a support arm is formed to support the second movable part at a second separated position; the stopper is provided on each of one side and the other side in a width direction; the catching part is provided on each of the one side and the other side; the support arm is provided on each of the one side and the other side; and the detection unit is provided on one of the one side and the other side.

### CROSS-REFERENCE TO RELATED APPLICATION

This application claims priority under 35 U.S.C. §119 from Japanese Patent Application No. 2012-163687, filed on Jul. 24, 2012. The entire subject matter of the application is incorporated herein by reference.

### BACKGROUND

1. Technical Field

Aspects of the present invention relate to an image processing apparatus.

2. Related Art

As an example of an image processing apparatus, an image forming apparatus having a printer unit (provided as an example of a main body) and a reading unit (provided as an example of a movable part) configured to be able to swing about a first swing axis at a rear side of the printer unit has been provided. In the image forming apparatus of this type, the reading unit is able to move between a first placement position where the reading unit is placed on the printer unit and a first separated position where the reading unit is separated from the printer unit 1.

The printer unit has a pair of side frames, an image formation unit and a body cover. The pair of side frames forms surfaces respectively intersecting with the first swing axis, and the body cover includes a pair of side covers externally covering the pair of side frames. Furthermore, the body cover is formed to have an upper opening through which the image formation unit is exposed upward when the reading unit is at the first separated position and a maintenance cover is opened.

Between the printer unit and the reading unit, a paper ejection space is formed. The paper ejection space serves as a discharge tray to which a sheet of paper for which image formation has been performed is ejected. That is, the image forming apparatus is configured as a so-called in-body paper ejection type.

In the image forming apparatus, by swinging the reading unit to the first separated position, a small-sized sheet of paper ejected on the back side of the paper ejection space can be picked up easily. Regarding maintenance work of the image formation unit, work for replacing of replacements such as a cartridge and work for resolving of jamming can be performed by moving the reading unit to the first separated position and opening the maintenance cover (i.e., an upper cover of the printer unit) forming a part of the discharge tray so that the upper opening is opened and the image formation unit is exposed.

### SUMMARY

Incidentally, regarding image processing apparatuses of the above described conventional type, improvement of performance (e.g., colorizing of the image formation unit) is progressing. Therefore, the size and the number replacements accommodated in the main body are also increasing. In addition, there is a demand for speeding up work for resolving jamming. In this regard, work for replacing of replacements and work for resolving jamming are hard to conduct because an opening under the maintenance cover is small. Therefore, a designer of the image processing apparatus might consider designing the image forming apparatus such that the upper side of the main body is largely opened. In this case, it is necessary to open the upper surface of the main body together with the moving part, but as described above the image processing unit can be exposed upward through the more largely formed opening in comparison with the above described case where the maintenance cover is opened. Such a configuration makes is possible to conduct maintenance work for the image processing unit more easily.

However, in order to configure the upper cover of the main body to be openable/closable, it is necessary to provide a locking mechanism for locking the main body side and the upper cover side so as to prevent that the upper cover from being opened in an undesirable manner. Furthermore, it is necessary to provide a sensor to detect whether the upper cover is properly locked to the main body so as to prevent malfunction of the apparatus. In these circumstances, it is required to carefully consider the position for locking the main body and the upper cover and the position for the sensor.

Aspects of the present invention are advantageous in that they provide an image processing apparatus capable of preventing occurrence malfunction, while making it possible to easily conduct maintenance work for an image processing unit.

According to an aspect of the invention, there is provided an image processing apparatus, comprising: a main body comprising an upper opening formed in an upper portion of the main body, the main body being configured to accommodate an image processing unit configured to perform image processing; a first movable part configured to be swingable about a first axis extending in a width direction with respect to the main body, and to move between a first placement position where the first movable part is positioned on the main body and covers the upper opening and a first separated position where the first movable part is separated from the main body and exposes the upper opening; a second movable part configured to be swingable about a second axis parallel with the first axis, and to move between a second placement position where the second movable part is positioned on the first movable part and a second separated position where the second movable part is separated from the first movable part; a locking mechanism configured to place the main body and the first movable part to a locked state or an unlocked state; and a detection unit configured to detect a state of the locking mechanism. In this configuration, the locking mechanism and the detection unit are arranged between the main body and the first movable part. The locking mechanism comprises: a stopper provided on one of the main body and the first movable part; and a catching part provided on the other of the main body and the first movable part, the catching part being formed to engage with the stopper. A support arm is provided between the first movable part and the second movable part such that a lower end portion of the support arm is attached to the first movable part and an upper end portion of the support arm is attached to the second movable part, the support arms being formed to support the second movable part at a fixed position when the second movable part is at the second separated position. The stopper is provided on each of one side and the other side in the width direction, the catching part is provided on each of the one side and the other side in the width direction, the support arm is provided on each of the one side and the other side in the width direction, and the detection unit is provided on one of the one side and the other side in the width direction.

### BRIEF DESCRIPTION OF THE ACCOMPANYING DRAWINGS

FIG. 1 is a perspective view illustrating an image forming apparatus according to a first embodiment in a state where a joint cover is at a first placement position.

FIG. 2 is a perspective view schematically illustrating the image forming apparatus according to the first embodiment in a state where the joint cover is at the first placement position.

FIG. 3 is a perspective view illustrating the image forming apparatus according to the first embodiment in a state where the joint cover is at a first separated position.

FIG. 4 is a perspective view illustrating the image forming apparatus according to the first embodiment in a state where a reading device is at a second separated position.

FIG. 5 is a perspective view of a locking member of the image forming apparatus according to the first embodiment.

FIG. 6 is a right side view illustrating the image forming apparatus according to the first embodiment in a state where the joint cover is at the first placement position.

FIG. 7 is a right side view illustrating the image forming apparatus according to the first embodiment in a state where the reading device is at the second separated position.

FIG. 8 is a right side view illustrating the image forming apparatus according to the first embodiment in a state where an automatic document feeder is at a third separated position.

FIG. 9 is a front view illustrating the image forming apparatus according to the first embodiment in a state where the reading device is at the second separated position.

FIG. 10 is a cross section of the image forming apparatus according to the first embodiment taken along an arrow A-A in FIG. 9.

FIG. 11 is an enlarged cross section of the image forming apparatus according to the first embodiment taken along the arrow A-A in FIG. 9.

FIG. 12 is an enlarged cross section of the image forming apparatus according to the first embodiment taken along an arrow B-B in FIG. 9.

FIG. 13 is a front view of an image forming apparatus according to a second embodiment in a state where the reading device is at the second separated position.

### DETAILED DESCRIPTION

Hereafter, first and second embodiments according to the invention will be described with reference to the accompanying drawings.

### First Embodiment

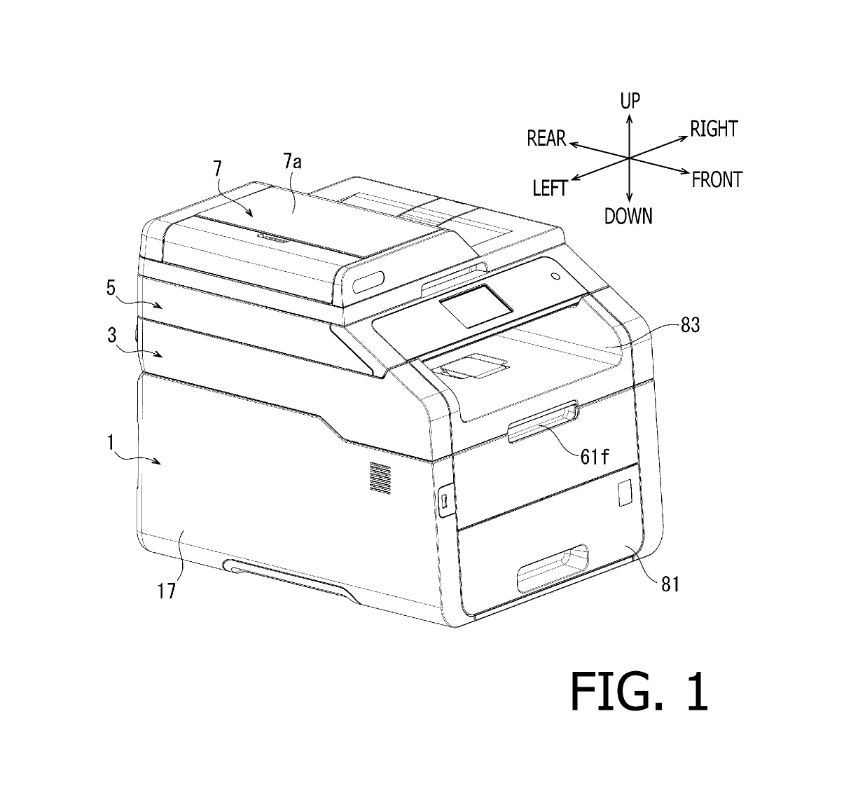

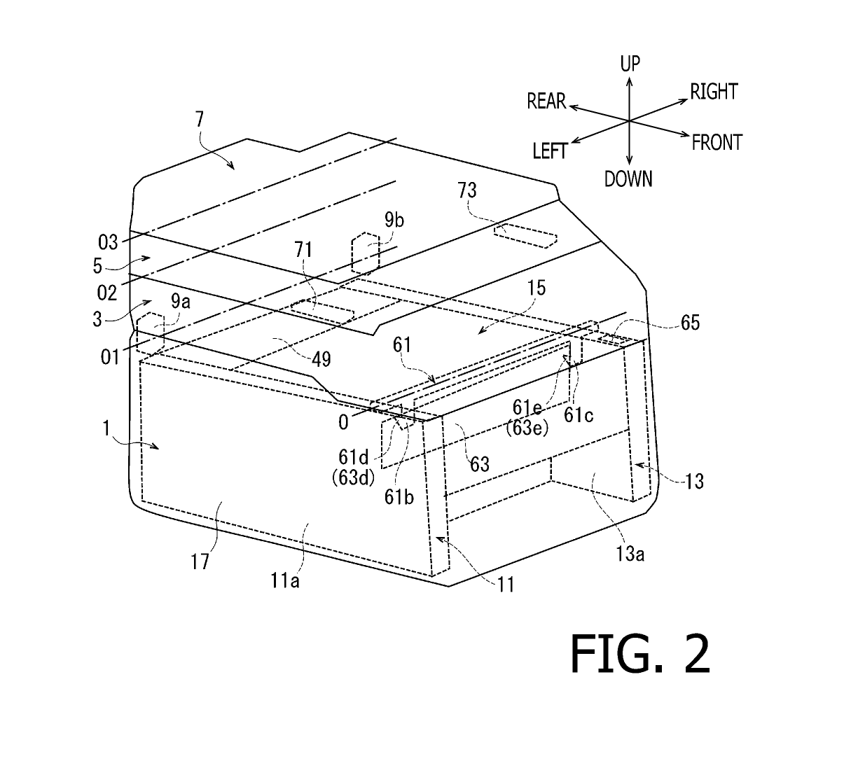

As shown in FIG. 1, an image forming apparatus according to a first embodiment is a specific example of an image processing apparatus according to the invention. In FIG. 1, a direction in which a paper supply tray 81 is drawn and an opening side of a discharge tray 83 are defined as a front side of the image forming apparatus, the left-hand side defined when facing the direction in which the paper supply tray 81 is drawn and the opening side of the discharge tray 83 is defined as a left side of the image forming apparatus, and the front, rear, left, right, up and down directions are represented accordingly. Directions shown in the drawings from FIG. 2 are defined according to the directions defined in FIG. 1.

(Configuration of Image Forming Apparatus)

As shown in FIG. 1, the image forming apparatus includes a printer unit 1 (an example of a main body), a joint cover 3 provided above the printer unit 1, a reading device 5 provided above the joint cover 3, and an automatic document feeder 7 provided above the reading device 5.

Hereafter, configurations of the printer unit 1 and the joint cover 3 will be explained. As shown in FIGS. 2 and 6, between the printer unit 1 and the joint cover 3, a pair of first hinges 9a and 9b which allows the printer unit 1 and the joint cover 3 to swing about a first swing axis O1 is provided. As shown in FIG. 2, the printer unit 1 has a pair of metal side frames 11 and 13 respectively forming surfaces 11a and 13a intersecting with the first swing axis O1. An image formation unit 15 which performs image formation on a sheet-like medium is supported on the surfaces 11a and 13a of the pair of side frames 11 and 13. It should be noted that, in this embodiment, the side frames 11 and 13 are arranged to perpendicularly intersect with the first swing axis O1; however, in another embodiment the side frames may be arranged such that an interval defined therebetween gradually increases from the rear side to the front side, or may be arranged such that the interval defined therebetween gradually decreases from the rear side to the front side. The flat surface part of the side frame is not limited to the above described structure, and may be formed to have an uneven part or may be inclined.

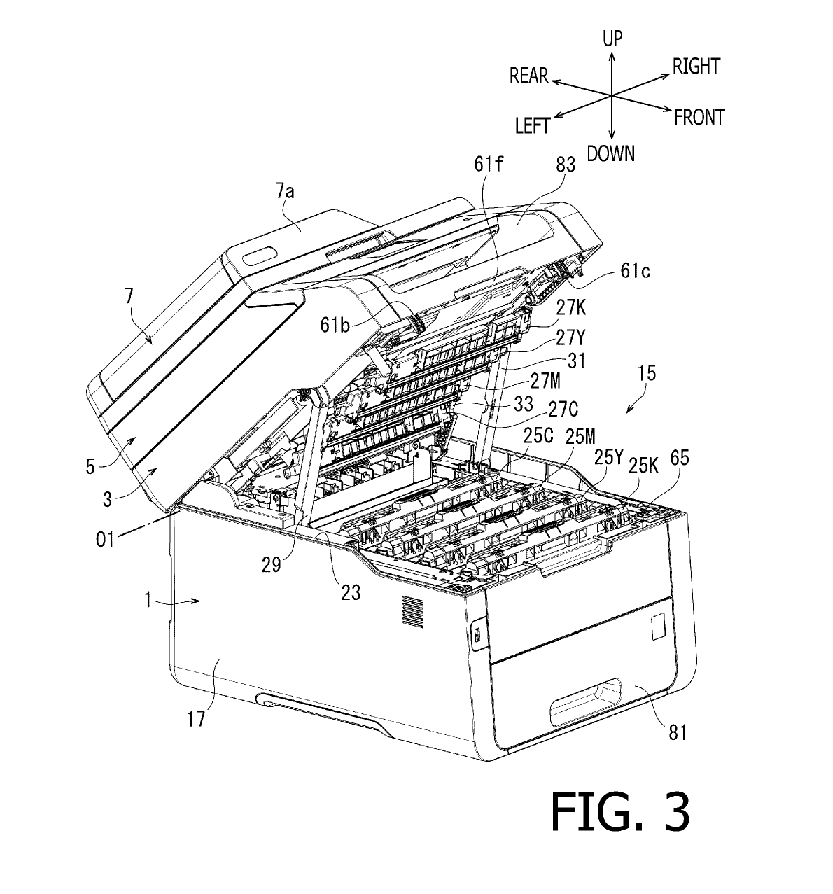

The side frames 11 and 13 are covered with a body cover 17 made of resin. As shown in FIG. 1, the paper supply tray 81 is attached to the body cover 17 such that the paper supply tray 81 can be drawn to the front side. An upper side of the paper supply tray 81 is covered with a front cover 22. The joint cover 3 is arranged to be able to move between a first placement position at which the joint cover 3 is placed on the printer unit 1 as shown in FIGS. 1 and 2 and a first separated position to which the joint cover 3 swings upward about the first swing axis O1 as shown in FIG. 3. An upper opening 23 which lets the image formation unit 15 be exposed to the outside upwardly when the joint cover 3 is at the first separated position is formed in the body cover 17. That is, the upper opening 23 is a space surrounded by the upper edges of the side covers 19 and 21, the front cover 22 and a rear cover 24.

The image formation unit 15 has four cartridges 25K, 25Y, 25M and 25C. The cartridge 25K corresponds to black, the cartridge 25Y corresponds to yellow, the cartridge 25M corresponds to magenta and the cartridge 25C corresponds to cyan. Each of the cartridges 25K, 25Y, 25M and 25C has a photosensitive drum, a development roller and a charger as well as a toner reservoir. The cartridges 25K, 25Y, 25M and 25C are examples of replacements.

The image formation unit 15 has four LED heads 27K, 27Y, 27M and 27C. Each of the LED heads 27K, 27Y, 27M and 27C is hung from the lower surface of the joint cover 3, and is attached to the joint cover 3 to be able to swing in the front-back direction with respect to an upper end part thereof. The LED head 27K corresponds to black, the LED head 27Y corresponds to yellow, the LED head 27M corresponds to magenta and the LED head 27C corresponds to cyan.

Furthermore, as shown in FIG. 2, the image formation unit 15 has a control unit 49 formed of components such as a substrate and wiring. The control unit 49 is arranged in a rear portion near the first swing axis O1, i.e., on the rear side of the upper opening 23. In the printer unit 1, a conveying unit (not shown) including rollers, a conveying belt and guide parts for conveying the sheet-like medium in the paper supply tray 18 to the image formation unit 15 and for ejecting the sheet-like medium to the discharge tray 83 is also provided. By driving the image formation unit 15 and the conveying unit, the control unit 49 forms an image on the sheet-like medium accommodated in the paper supply tray 81.

As shown in FIG. 3, the joint cover 3 is provided to be able to swing about the first swing axis O1 by the first hinges 9a and 9b with respect to the printer unit 1. The joint cover 3 is able to move between the first placement position where the joint cover 3 is placed on the printer unit 1 and the first separated position where the joint cover 3 is separated from the printer unit 1. The joint cover 3 is an example of a first movable part.

Between the printer unit 1 and the joint cover 3, a pair of support arms 29 and 31 and a link arm 33 are provided. Each of the support arms 29 and 31 is configured to hold the position of the joint cover 3 when the joint cover 3 is at the first separated position. The link arm 33 is provided such that, by swinging the joint cover 3 to the first separated position, the LED heads 27K, 27Y, 27M and 27C are inclined and the lower end of each of the LED heads 27K, 27Y, 27M and 27C is oriented to the first swing axis O1.

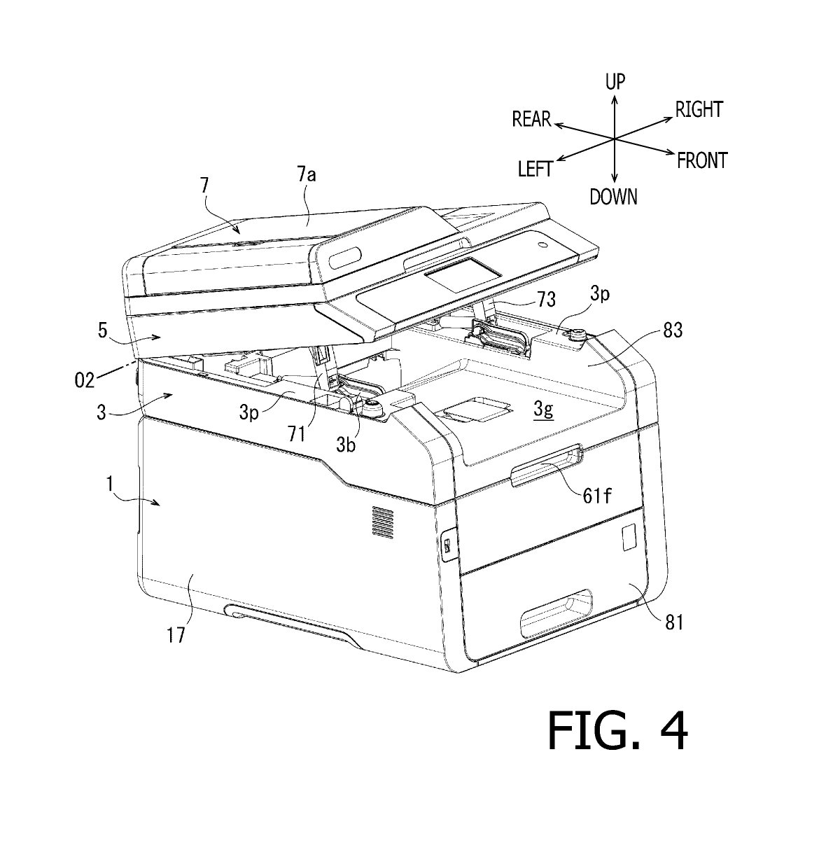

Configurations of the joint cover 4 and the reading device 5 will be explained. As shown in FIGS. 4 and 6, a pair of second hinges (not shown) is provided on the rear side between the joint cover 3 and the reading device 5, and the reading device 5 is able to swing about a second swing axis O2 by the second hinges with respect to the joint cover 3. The second swing axis O2 is parallel with the first swing axis O1, and is situated on the upper side of the first swing axis O1.

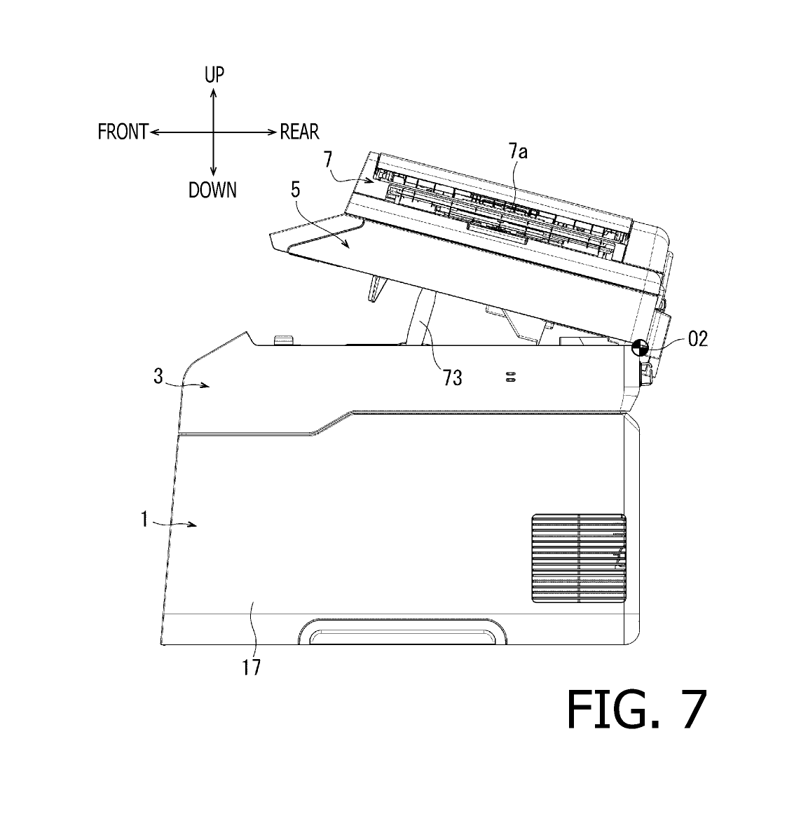

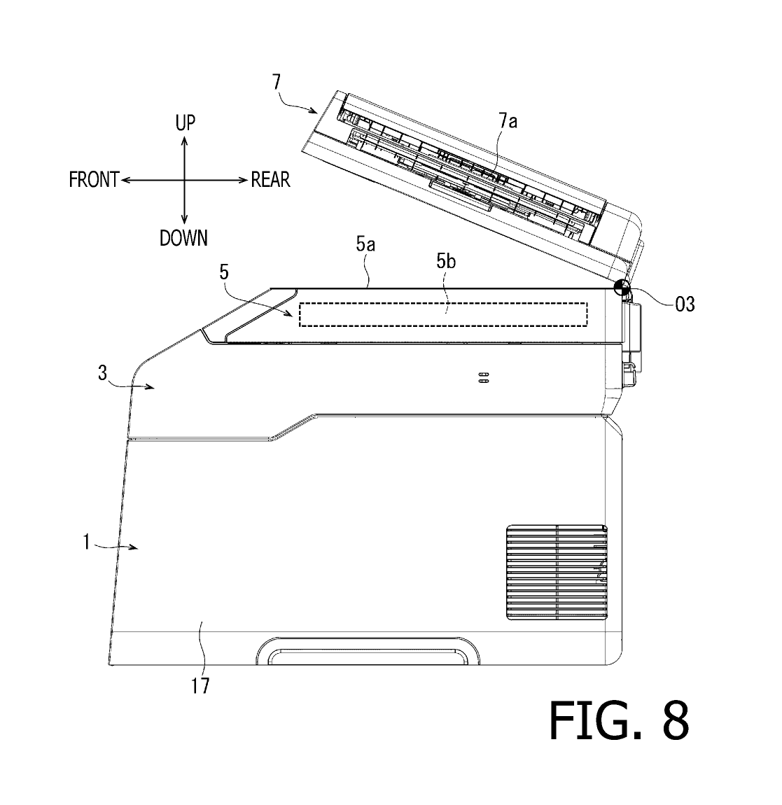

The reading device 5 is able to move between a second placement position where the reading device 5 is placed on the joint cover 3 as shown in FIG. 6 and a second separated position where the reading device 5 is separated from the joint cover 3 as shown in FIG. 7. As shown in FIG. 4, the upper surface of the joint cover 3 has, at right and left end portions thereof, placement areas 3p on which the reading device 5 is placed with respect to the joint cover 3, and a non-contact area 3g which is formed, in a central portion in the width direction, to be recessed with respect to the placement areas 3p and where the joint cover 3 and the reading device 5 are in a non-contact state even when the reading device 5 is at the second placement position. The non-contact area 3g functions as the discharge tray 83 communicating with a sheet ejection hole of the printer unit 1. By positioning the reading device 5 at the second separated position, it becomes possible to easily pick up a small-sized sheet-like medium ejected at the back side of the discharge tray 83. The reading device 5 also serves to prevent the sheet-like medium stacked on the discharge tray 83 from being scattered. As shown in FIG. 8, the reading device 5 has a placement surface 5a on which a document is placed and a reading unit 5b which reads an image on the document placed on the placement surface 5a while moving. The reading device 5 is an example of a second movable part. Since the reading unit 5b has a known configuration, detailed explanation thereof is omitted.

As shown in FIGS. 4, 7, 9 and 10, a pair of support arms 71 and 73 is provided between the joint cover 3 and the reading device 5. The support arm 71 is provided in an area which is inside the placement area 3p formed on the left side in the width direction of the image forming apparatus and which is positioned to be lower than the placement area 3p. The support arm 73 is provided in the placement area 3p formed on the right side in the width direction of the image forming apparatus. As shown in FIG. 10, the upper end 71b of the support arm 71 is attached to the reading device 5 to be able to pivot. The joint cover 3 has, at both ends thereof, guide parts 3b (only one of which is shown in FIG. 10) each of which as a slit 3a formed to extend horizontally, so that a projection 71a formed on a lower end part of the support arm 71 is able to roll in the slit 3a. The rear part of the slit 3a is formed to extend upward, so that when the projection 71a reaches the rear end of the slit 3a and is stopped while contacting the inner edge of the rear end of the slit 3a, the reading device 5 is held at the second separated position. In addition, the front part of the slit 3a is formed to extend downward, so that when the projection 71a of the support arm 71 reaches the front end of the slit 3a and is stopped while contacting the inner edge of the front end of the slit 3a, the reading device 5 is held at the second placement position. Since the support arm 73 is plane symmetrical with the support arm 71, detailed explanations and illustrations thereof are omitted.

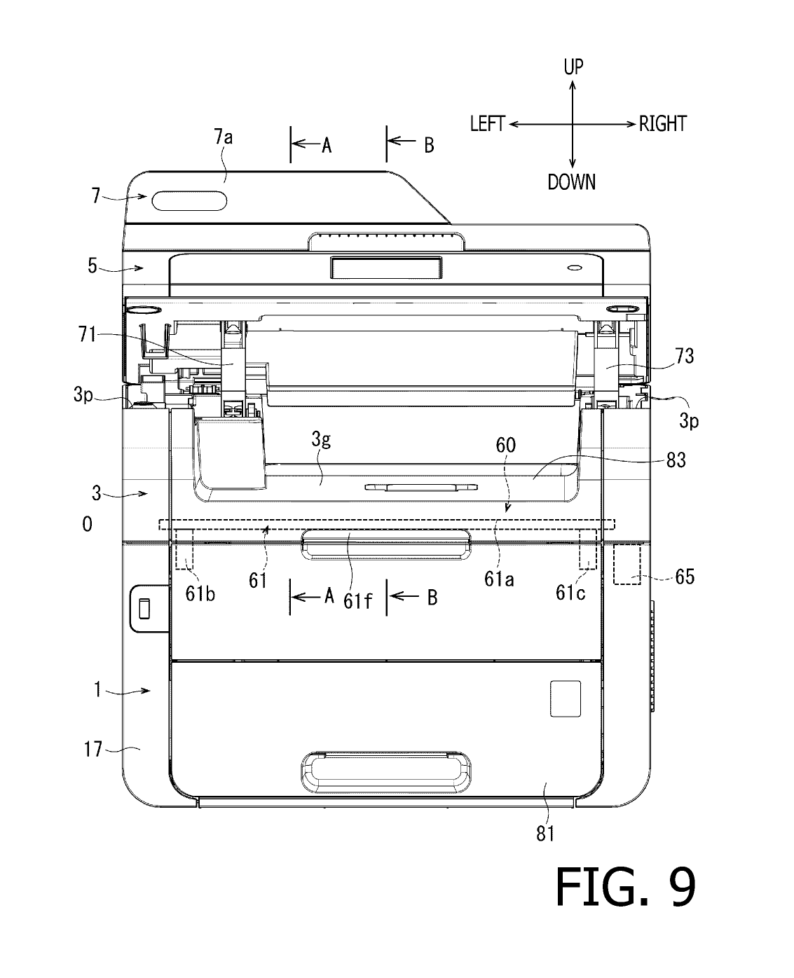

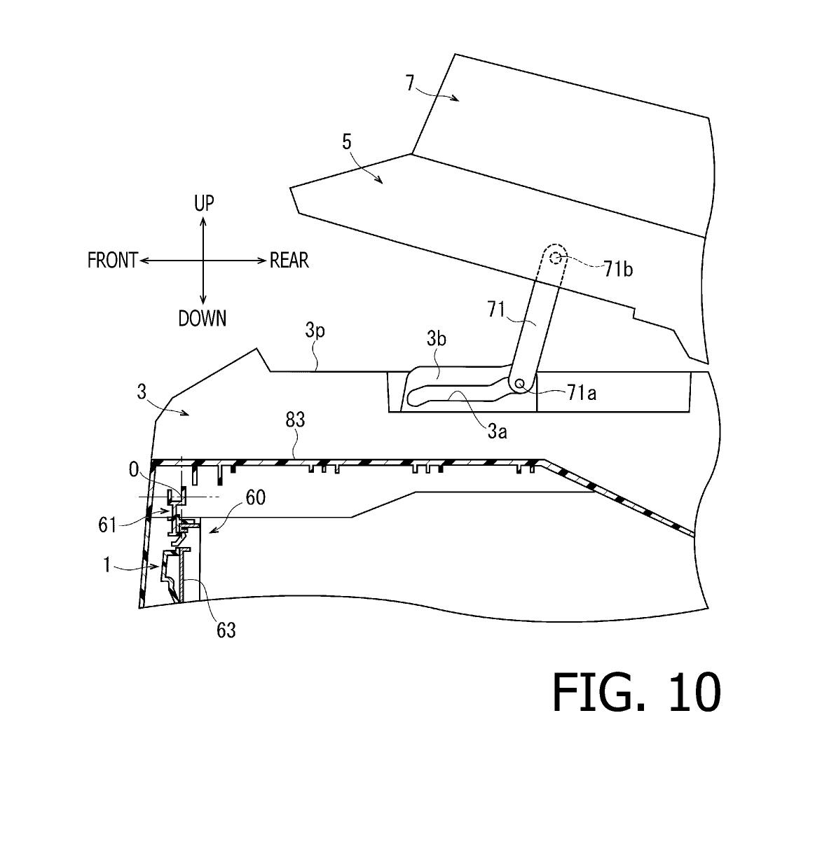

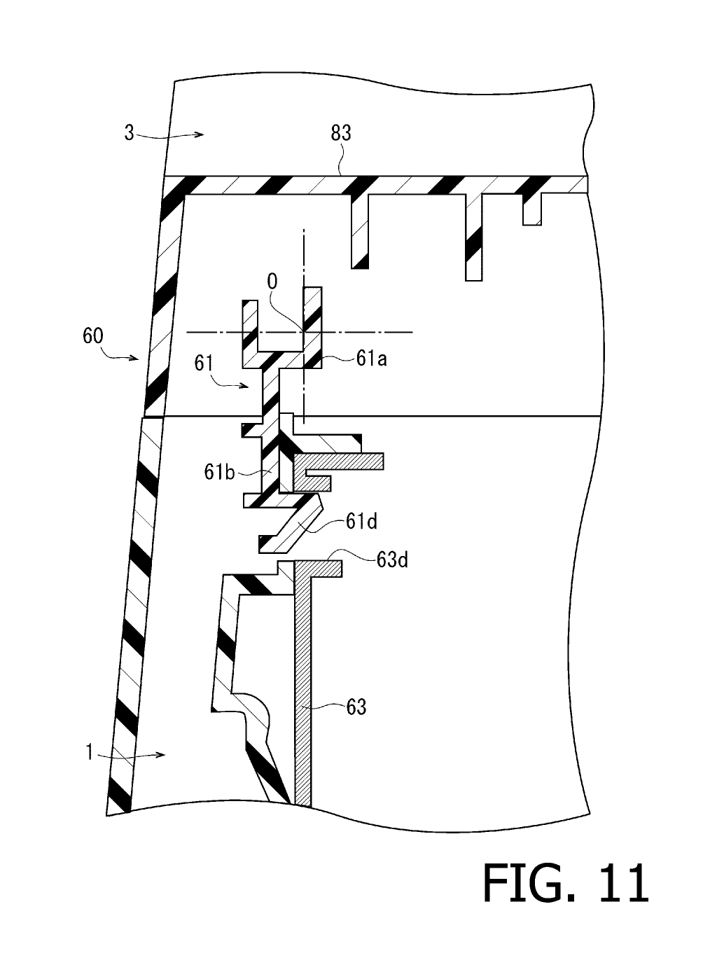

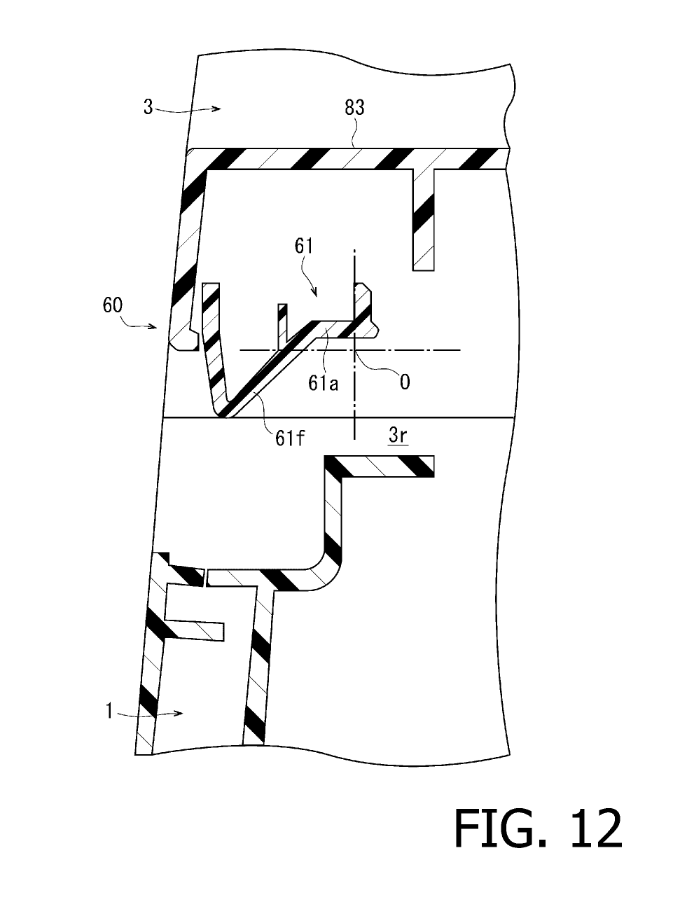

As shown in FIGS. 2 and 9, a locking mechanism 60 configured to lock or unlock the printer unit 1 and the joint cover 3 is provided between the printer unit 1 and the joint cover 3. The locking mechanism 60 includes a locking member 61 and a front frame 63 shown in FIGS. 10 and 11.

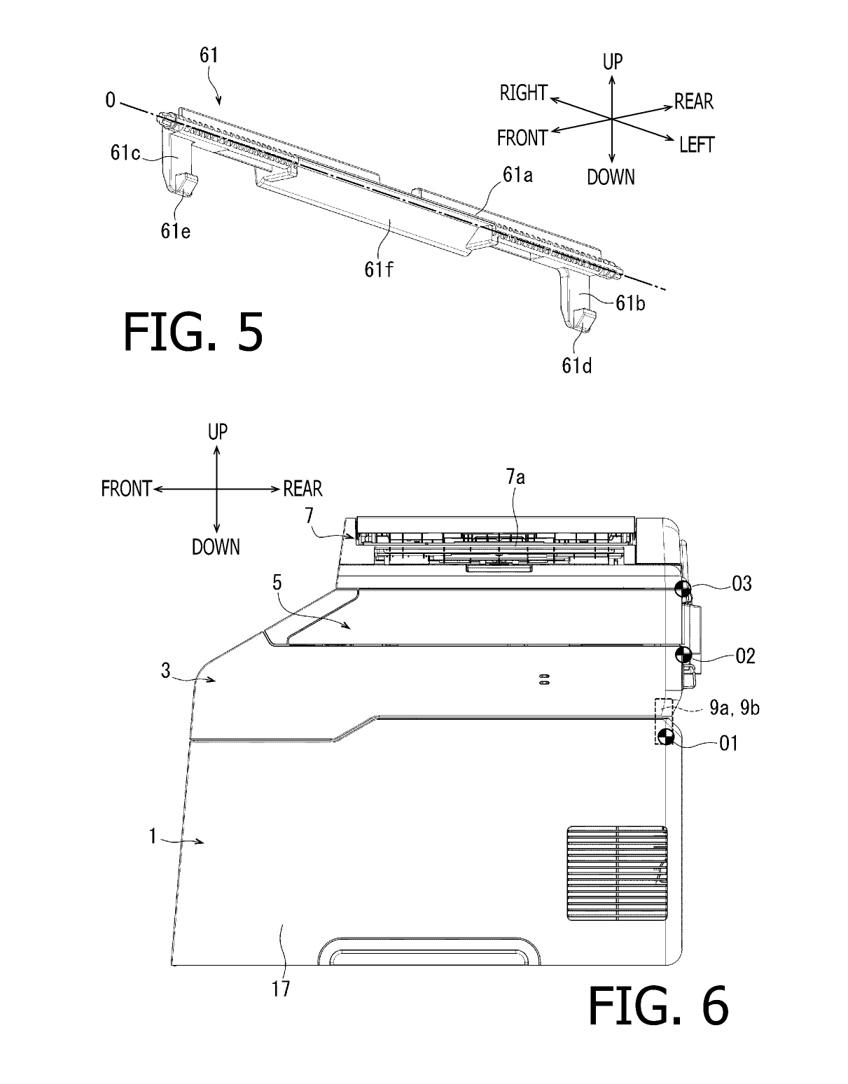

As shown in FIG. 2, the locking member 61 is provided on the front surface side of the joint cover 3, and has a rod 61a extending in the left and right direction. Both ends of the rod 61a are supported by side frames (not shown), and the rod 61a is able to rotate about an axis parallel with the second swing axis O2. As shown in FIG. 5, at both ends of the rod 61a, locking arms 61b and 61c are provided integrally with the rod 61a along directions intersecting with the rod 61a. At tip ends of the locking arms 61b and 61c, nails 61d and 61e functioning as stoppers are integrally formed. In a state where the locking arms 61b and 61c are situated to extend downward from the rod 61a, the nails 61d and 61e projects backward. At a central portion of the rod 61a, a lever 61f functioning as an operation member is formed.

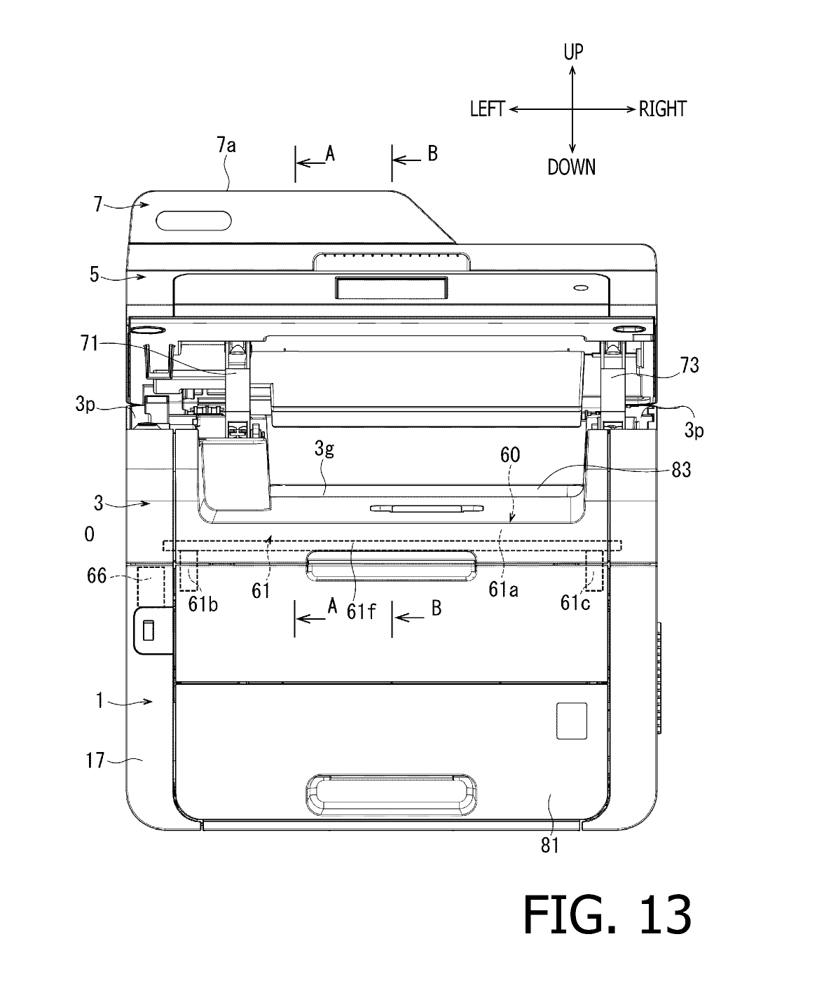

As shown in FIG. 2, in the printer unit 1, a metal front frame 63 which connects the side frame 11 with the side frame 13 on the front side is provided. At both ends of the front frame 63, engagement holes 63d and 63e serving as catching parts are formed to penetrate therethrough (only one of which is shown in FIG. 11). As shown in FIG. 5, the lever 61f of the locking member 61 is formed such that, in a state where the locking arms 61b and 61c extend downward from the rod 61a, the lever 61f is inclined upward from the front side toward the rear side. Therefore, as shown in FIG. 12, when a user holds the user's finger cushion to the lever 61f and then lifts the lever 61f, the rod 61a swings about an axis O. As a result, upper surfaces of the nails 61d and 61e moves from a position where the upper surfaces of the nails 61d and 61e engages with upper edges of the engagement holes 63d and 63e to a position where the upper surfaces of the nails 61d and 61e are released from the engagement holes 63d and 63e. That is, the nails 61d and 61e of the locking member 61 functioning as stoppers in the locking mechanism 60 are provided at positions corresponding to the engagement holes 63d and 63e (serving as catching parts) formed in the side frames 11 and 13 provided at both ends of the printer unit 1. With this configuration, when the joint cover 3 is at the first placement position, the joint cover 3 is locked to the printer unit 1.

As shown in FIG. 12, between the printer unit 1 and the joint cover 3, an operation space 3r through which the user is able to operate the lever 6f even when the joint cover 3 is at the first placement position is formed. The operation space 3r is formed to be slightly larger than an adult's finger. Therefore, when the joint cover 3 at the first placement position is moved to the first separated position, the user is able to easily operate the lever 6f. When viewed from the front side, the operation space 3r is blocked by the lever 6f. Such a configuration makes it possible to prevent the operation space 3r from being viewed like a gap, and therefore the outer appearance of the image forming apparatus can be enhanced.

Furthermore, as shown in FIGS. 2, 3 and 9, on the front side of the upper edge of the side frame 13, a detection unit 65 which detects a state of the locking mechanism 61 is provided at the position between the printer unit 1 and the joint cover 3.

As shown in FIG. 2, on the right side of the image forming apparatus, the support arm 73, the nail 61e, the engagement hole 63e and the detection unit 65 are arranged in this order from the rear side to the front side.

As shown in FIG. 6, between the reading device 5 and the automatic document feeder 7, a pair of third hinges (not shown) is provided on the rear side of the reading device 5 and the automatic document feeder 7. The automatic document feeder 7 is provided to be able to swing about a third swing axis O3 by the third hinges with respect to the reading device 5. The third swing axis O3 is in parallel with the first and second swing axes O1 and O2, and is situated right above the second swing axis O2.

The automatic document feeder 7 is able to move between a third placement position where the automatic document feeder 7 is placed on the reading device 5 and covers the placement surface 5a as shown in FIG. 6 and a third separated position where the automatic document feeder 7 is separated from the reading device 5 as shown in FIG. 8. The automatic document feeder 7 has a conveying unit 7a which conveys the document toward the reading unit 5a situated at a stop position. The automatic document feeder is an example a cover member (i.e., a third movable part).

(Operation of Image Forming Apparatus According to the First Embodiment)

In addition to the printing function by the image formation unit 15, the above described image forming apparatus is able to execute the copying function. For example, when the copying function is designated, a document set on the document supply unit of the automatic document feeder 7 is conveyed to the reading unit 5b of the reading device 5 by the conveying unit 7a, and an image of the document is read by the reading unit 5b. Image data read by the reading unit 5b is stored in a storage device (not shown) of the control unit 49, and is converted into print data by a controller (not shown) included in the control unit 49. The image formation unit 15 is driven by the control unit 49, the sheet-like medium in the paper supply tray 81 is conveyed, and an image based on the print data is formed on the sheet-like medium. Then, the sheet-like medium on which the image has been formed is ejected to the discharge tray 83.

In the image forming apparatus, the joint cover 3 is able to swing about the first swing axis O1 with respect to the printer unit 1, and the reading device 5 is able to swing about the second swing axis O2 with respect to the joint cover 3. Therefore, when maintenance work for the image formation unit 15 is to be conducted, the joint cover 3 is swung about the first swing axis O1 to the first separated position in the state where the reading device 5 is at the second placement position as shown in FIG. 3. As a result, the upper side of the printer unit 1 is opened largely, and the upper opening 23 located on the upper side of the image formation unit 15 can be exposed. Thus, it becomes possible to easily conduct work for replacement for the cartridges 25K, 25Y, 25M and 25C in the printer unit 1 and for solving jamming in the printer unit 1.

Since, in the image forming apparatus, the barycenter of the reading device 5 is moved by the weight of the automatic document feeder 7 when the reading device e5 is at the second separated position, the both ends of the joint cover 3 in the width direction can be lifted easily. Furthermore, by accommodating the reading unit 5b, the weight of the reading device 5 itself is heavy. Therefore, a force by which the joint cover 3 is drawn and a force by which the joint cover 3 pushed during opening/closing operation for the reading device 5 become large.

In the image forming apparatus, the upper opening 23 of the printer unit 1 is formed by the upper edges of the front, rear, left and right upper edges of the body cover 17, and the upper opening 23 is formed as a opening largely formed in the front and rear direction and in the left and right direction. In this case, by moving the joint cover 3, the image formation unit 15 can be exposed largely through the upper opening 23 of the printer unit 1, thereby making it easier to conduct maintenance work.

Since the support arms 71 and 73 are provided in the placement area 3p and an area near the placement area 3, the joint cover 3 is formed such that an inter mediate part thereof in the width direction becomes thinner by providing the non-contact area 3g, and therefore the joint cover 3 is easy to warp. Therefore, when the reading device 5 is lifted, the both end sides (the placement area 3p side) of the joint cover 3 become easy to lift upward. In the image forming apparatus, the support arms 71 and 73 are provided at the both ends of the joint cover 3 (in this embodiment, the support arm 71 is provided at the inside of the leftward placement area 3p, and the support arm 73 is provided in the rightward placement area 3p). Therefore, by providing the locking mechanism at the both ends of the apparatus, it becomes possible to suitably prevent the both ends of the joint cover 3 from being lifted by a force for holding the locked state of the locking mechanism and to suitably prevent occurrence of an erroneous detection by the detector unit provided at the end part of the apparatus.

In particular, in the image forming apparatus, the nails 61d and 61e and the engagement holes 63d and 63e of the locking mechanism 61 are provided respectively on the left and right sides of the apparatus, and the support arms 71 and 73 are also provided on the left and right sides of the apparatus. In addition, the detection unit 65 is provided on the right side. Therefore, even when the reading device 5 is moved to the second separated position, the locking mechanism 61 is able to prevent the both ends of the joint cover 3 are lifted via the support arms 71 and 73. Consequently, an erroneous detection by the detection unit 65 can be prevented suitably.

In the image forming apparatus, the support arm 73, the nail 61e, the engagement hole 63e and the detection unit 65 are arranged, on the right side of the apparatus, in this order from the rear side to the front side. Therefore, it becomes possible to prevent deformation of the joint cover 3 by absorbing a force acting on the support arm 73 by the nail 61e and the engagement hole 63e, and thereby to securely prevent occurrence of an erroneous detection by the detection unit 65.

In the image forming apparatus, the nails 61d and 61e and the engagement holes 63d and 63e provided on the both sides can be unlocked by operating the lever 6f provided in the central portion on the front side of the apparatus as shown in FIG. 3. Such a configuration allows the user to easily conduct operation for moving the joint cover 3 to the first separated position.

In particular, since the engagement holes 63d and 63e are formed in the metal front frame 63 having a high degree of rigidity as shown in FIG. 11, the locked state of the nails 61d and 61e can be made stable. The locking member 61 is formed as an integrated component of the rod 61a, the locking arms 61b and 61c, the nails 61d and 61e and the lever 61f, the number of components can be decreased, and thereby the manufacturing cost can be decreased. It should be noted that the locking member 61 including the rod 61a and the lever 61f may be formed integrally by resin molding, or may be formed by assembling separate parts.

Since the operation space 3r is formed between the printer unit 1 and the joint cover 3 as shown in FIG. 12, the lever 61f can be operated easily even when the joint cover 3 is at the first placement position, and operation for moving the joint cover 3 to the first separated position can be conducted easily.

Therefore, according to the image forming apparatus, it is possible to easily conduct maintenance work for the image formation unit 15 and to prevent occurrence of malfunction of the apparatus.

### Second Embodiment

As shown in FIG. 13, in an image forming apparatus according to a second embodiment, a detection unit 66 is arranged on the left side of the apparatus. Therefore, in the image forming apparatus, the nail 61d and the engagement hole 63d are located between the support arm 71 and the detection unit 66. Other configurations in the second embodiment are the same as those of the first embodiment.

The image forming apparatus according to the second embodiment is also able to prevent deformation of the joint cover 3 by absorbing the force acting on the support arm 71 by the nail 61d and the engagement hole 63d, and to prevent occurrence of erroneous detection by the detection unit securely. Other advantages of the second embodiments are the same as those of the first embodiment.

In the foregoing, the present invention is explained with reference to the first and second embodiments; however, the invention is not limited to the above described first and second embodiments, and can be varied without departing from the scope of the invention.

For example, the configuration of the locking mechanism 61 is not limited to the above described embodiments, and engagement holes may be formed on the joint cover 3 and nails may be provided on the printer unit 1. Furthermore, the shape of the locking mechanism 61 is not limited to the above described embodiments as long as the locked state and the unlocked state can be switched by operating a lever.

In the above described first and second embodiments, the image forming apparatus is configured as a so-called in-body paper ejection type; however, the invention is not limited to such a configuration. For example, the reading device 5 may be able to move between a placement position and a separated position on the printer unit 1, and a device having a different function may be provided to be movable.

The first, second and third swing axes O1, O2 and O3 may not necessarily be arranged to be parallel with each other. The third swing axis O3 may be provided to intersect with the other axes. In the above described first and second embodiments, the first to third swing axes O1 to O3 are provided at the rear end of the apparatus; however, the positions of the first to third swing axes O1 to O3 are not limited to the above described embodiments. For example, the first to third swing axes O1 to O3 may be provided at a position closer to the front side.

The configuration of the hinges 9a and 9b is not limited to the above described embodiments where they swing about the first swing axis O1. As long as the joint cover 3 is movable between the placement position and the separated position with respect to the printer unit 1, the hinges 9a and 9b may be configured such that the hinges rotate while the rotation axis moves or may be configured to have a sliding structure. The same applies to the second hinge 39 and the third hinge 41.

In the above described embodiments, the leftward support arm 71 is arranged inside the placement area 3p; however, the leftward support arm 71 may be arranged in the placement area 3p.

What is claimed is:

1. An image processing apparatus, comprising:
a main body comprising an upper opening formed in an upper portion of the main body, the main body being configured to accommodate an image processing unit configured to perform image processing;
a first movable part configured to be swingable about a first axis extending in a width direction with respect to the main body, and to move between a first placement position where the first movable part is positioned on the main body and covers the upper opening and a first separated position where the first movable part is separated from the main body and exposes the upper opening;
a second movable part configured to be swingable about a second axis parallel with the first axis, and to move between a second placement position where the second movable part is positioned on the first movable part and a second separated position where the second movable part is separated from the first movable part;
a locking mechanism configured to place the main body and the first movable part to a locked state or an unlocked state; and
a detection unit configured to detect a state of the locking mechanism,
wherein the locking mechanism and the detection unit are arranged between the main body and the first movable part,
wherein the locking mechanism comprises:
a stopper provided on one of the main body and the first movable part; and
a catching part provided on the other of the main body and the first movable part, the catching part being formed to engage with the stopper,
wherein:
a support arm is provided between the first movable part and the second movable part such that a lower end portion of the support arm is attached to the first movable part and an upper end portion of the support arm is attached to the second movable part, the support arm being formed to support the second movable part at a fixed position when the second movable part is at the second separated position;
the stopper is provided on each of one side and the other side in the width direction;
the catching part is provided on each of the one side and the other side in the width direction;
the support arm is provided on each of the one side and the other side in the width direction; and
the detection unit is provided on one of the one side and the other side in the width direction.

2. The image processing apparatus according to claim 1,
wherein an upper surface of the first movable part comprises:
a placement area arranged at each of the one side and the other side, the second movable part being placed on the first movable part at the placement area; and
a non-contact area situated between the one side and the other side in the width direction, the con-contact area being formed to be lower than the placement area so that in the non-contact area the second movable part does not contact the first movable part,
wherein the support arm is provided within the placement area.

3. The image processing apparatus according to claim 1,
wherein:
the locking mechanism comprises an operation part to be operated to place the stopper and the catching part from the locked state to the unlocked state;
the first axis and the second axis in the main body and the first movable part are provided on a rear side of the image processing apparatus; and
the operation part is provided in a central portion in the width direction on a front side of the image processing apparatus.

4. The image processing apparatus according to claim 1,
wherein the main body comprises:
a pair of side frames forming surfaces intersecting with the first axis; and
a metal front frame connecting the pair of side frames on the front side,
wherein the locking mechanism comprises:
a rod provided on the front side of the first movable part and configured to be swingable about an axis parallel with the second axis;
a nail formed integrally with the rod at each of both ends of the rod, the nail serving as the stopper;
an engagement hole formed in the metal front frame, the engagement hole serving as the catching part; and
a lever formed between the both ends of the rod to swing the rod from a position where the nail engages with the engagement hole to a position where the nail is separated from the engagement hole, the lever serving as the operation part.

5. The image processing apparatus according to claim 3, wherein an operation space through which the operation part is configured be operated even when the first movable part is at the first placement position is formed between the main body and the first movable part.

6. The image processing apparatus according to claim 4,
wherein the image processing unit is an image formation unit which is supported by the pair of side frames and is configured to form an image on a sheet, and
wherein the image formation unit comprises:
a placement part which needs to be replaced;
a control unit which does not need to be replaced,
wherein the upper opening is configured to expose the replacement part.

7. The image processing apparatus according to claim 6, wherein the replacement part is a cartridge which is detachable from the main body by being pulled out upward.

8. The image processing apparatus according to claim 6, wherein the replacement part is a consumable supply.

9. The image processing apparatus according to claim 1,
further comprising:
a third movable part configured to be swingable, with respect to the second movable part, about a third axis which is parallel with the first axis and the second axis, and to move between a third placement position where the third movable part is placed on the second movable part and a third separated position where the third movable part is separated from the second movable part.

10. The image processing apparatus according to claim 9, wherein the third axis is disposed on the rear side of the image processing apparatus, and is parallel with the first axis and the second axis.

11. The image processing apparatus according to claim 2, wherein the non-contact area of the first movable part is formed as a discharge tray configured to receive a sheet which is processed by the image processing unit.

12. The image processing apparatus according to claim 9,
wherein:
the second movable part is a reading device having a placement surface on which a sheet is placed and a reading unit which reads an image on the sheet placed on the placement surface; and
the third movable part is a cover configured to be movable between a position where the cover covers the placement surface and a position where the cover exposes the placement surface.

13. The image processing apparatus according to claim 11, wherein the cover comprises a conveying unit configured to convey a sheet toward the reading unit situated at a stop position.

14. The image processing apparatus according to claim 1, wherein on one of the one side and the other side in the width direction, the support arm, the stopper, the catching part and the detection unit are arranged in this order from the rear side to the front side.

15. The image processing apparatus according to claim 1, wherein on one of the one side and the other side where the detection unit is disposed, the locking mechanism is disposed between the support arm and the detection unit.
